(19) United States
(12) Patent Application Publication
(10) Pub. No.: US 2013/0207871 A1
(43) Pub. Date: Aug. 15, 2013

(54) Compact multi-band antenna with integrating fed through co-axial cable

(71) Applicant: Carlo Dinallo, Plantation, FL (US)

(72) Inventor: Carlo Dinallo, Plantation, FL (US)

(21) Appl. No.: 13/573,674

(22) Filed: Oct. 3, 2012

Related U.S. Application Data
(60) Provisional application No. 61/542,371, filed on Oct. 3, 2011.

(51) Int. Cl. H01Q 1/50

(52) U.S. Cl. CPC H01Q 1/50
USPC 343/860

(57) ABSTRACT

An antenna system comprises an antenna that integrates a separate fed through coaxial cable as part of its resonant structure. The fed through coaxial cable is used to feed a second antenna. This design allows for the antenna and the fed through cable to be accommodated in a very limited space at the edge of a handheld electronic device.

### CROSS REFERENCE TO RELATED APPLICATION

This patent application is based in part on provisional patent application 61/542,371, filed Oct. 3, 2011, and entitled “Compact Multi-Band Antenna With Integrating Fed Through Co-Axial Cable”.

### FIELD OF THE INVENTION

The present invention relates generally to antenna systems for handheld electronics.

### BACKGROUND

Modern handheld electronic devices such as smart phones and tablet computers are designed to contain electronics circuit boards and components at a very high density in a confined space. Furthermore in order to provide wireless connectivity through multiple standards such as cellular telephony standards and wireless Local Area Network (LAN) standards, or to support antenna diversity within a single standard, it is often desirable to accommodate multiple antennas in a single hand held electronic device. Space within the handheld device being very limited it is difficult to prevent one antenna or a feed conduit for an antenna which is capable of resonating radio waves from disrupting the operation of a second proximate antenna. Thus there is a need for antennas system that includes multiple antenna elements and can be accommodated within a limited space without causing mutual interference between the antennas and the feed systems for the antennas.

### BRIEF DESCRIPTION OF THE FIGURES

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1 is a partial x-ray front view of a handheld electronic device according to an embodiment of the invention;

FIG. 2 is a front view of an antenna used in the handheld electronic device shown in FIG. 1 according to an embodiment of the invention;

FIG. 3 is a back view of the antenna shown in FIG. 2;

FIG. 4 is a return loss plot for the antenna shown in FIGS. 2-3; and

FIG. 5 is a block diagram of the handheld electronic device shown in FIG. 1.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION

Before describing in detail embodiments that are in accordance with the present invention, it should be observed that the embodiments reside primarily in combinations of method steps and apparatus components related to antenna systems. Accordingly, the apparatus components and method steps have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

In this document, relational terms such as first and second, top and bottom, and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “comprises . . . a” does not, without more constraints, preclude the existence of additional identical elements in the process, method, article, or apparatus that comprises the element.

It will be appreciated that embodiments of the invention described herein may be comprised of one or more conventional processors and unique stored program instructions that control the one or more processors to implement, in conjunction with certain non-processor circuits, some, most, or all of the functions of hand held electronic devices described herein. The non-processor circuits may include, but are not limited to, a radio receiver, a radio transmitter, signal drivers, clock circuits, power source circuits, and user input devices. As such, these functions may be interpreted as steps of a method to perform hand held electronic device functions. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used. Thus, methods and means for these functions have been described herein. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

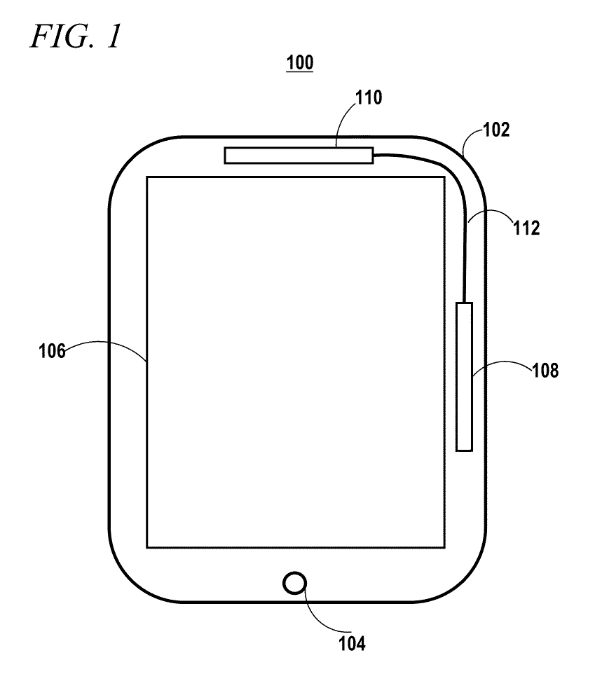

FIG. 1 shows a handheld electronic device 100 that is capable of wireless communication. The communication may for example comprise voice communication, image communication, video communication, text communication or other forms of communication. The device 100 includes a housing 102 which supports a single physical button 104 and a touch screen display 106. The housing 102 also encloses a first antenna 108 and a second antenna 110. The second antenna 110 is fed via a second antenna coaxial feed cable 112 that runs through the first antenna 108. Although the device 100 as shown in FIG. 1 takes the form of a Personal Digital Assistant PDA, which when equipped for cellular telephony is sometimes more recently referred to as a smart phone, alternatively the device may take other forms, such as for example a tablet computer, clam shell style cellular handset or a laptop computer.

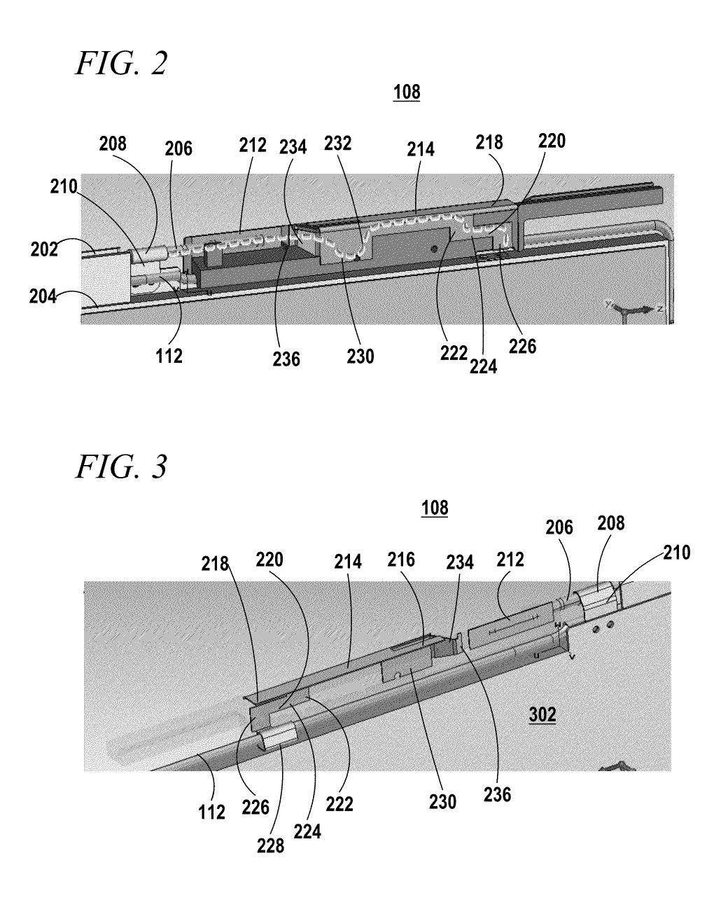

FIGS. 2-3 show front and back views of the first antenna 108. The device 100 includes a main ground structure 302. The main ground structure 302 may for example comprise a printed circuit board (PCB) with one or more ground plane layers and/or a stamped metal frame. The main ground structure 302 may serve as a ballast (or ‘counterpoise’) for the first antenna 108 and the second antenna 110. The first antenna 108 and the second antenna 110 are disposed proximate to the edges of the main ground structure 302. A channel 202 extends along a peripheral edge 204 of the main ground structure 302. The second antenna coaxial feed cable 112 and a first antenna coaxial feed cable 206 are routed through the channel 202.

The first antenna coaxial feed cable 206 is supported in a hooked end 208 of a clip 210 that is affixed by soldering or rivets or other device or method to the main ground structure 302. The outer conductor of the first antenna coaxial feed cable 206 connects to a metal feed strip 212. The inner conductor of the first antenna coaxial feed cable 206 is connected to the feed point 236 of the first antenna 108.

The first antenna 108 includes a first planar portion 214 that lies in a plane that is perpendicular to a plane aligned with the main ground structure 302. The first planar portion 214 includes a impedance matching stub 216 that extends toward the feed strip 212. An opposite end of the first planar portion 214 includes a high frequency tuning stub 218 that extends in a direction away from the feed strip 212.

A grounding conductor 220 extends from the first planar portion 214 at a right angle to the plane containing the first planar portion 214 (in a plane parallel to the plane of the ground structure 302) toward the main ground structure 302. The grounding conductor 220 follows a rectilinear zigzag path that includes a first short segment 222 extending toward the main ground structure 302, a second longer segment 224 extending in the direction away from the feed strip 212, and a third short segment 226 which again extends toward the main ground structure 302. Adapting the zigzag shape attains a longer electrical length to tune the antenna 108 without increasing the space requirement for the antenna. A hooked clip 228 extends from the far end of the third short segment 226 (opposite end from connection to second longer segment 224). The second antenna coaxial feed cable 112 runs from the channel 202 under the length of the first antenna 108 and is engaged in the hooked clip 228 so that a conductive connection is formed between the grounding conductor 220 and an outer conductor of the second antenna coaxial feed cable 112. In this design rather than contend with the issue of a nearby cable disturbing the performance of the first antenna 108, the cable 112 being routed through is actually electromagnetically integrated into the functioning of the first antenna 108.

The first antenna 108 also includes a depending tab 230 which extends perpendicular from the first planar portion 214 (in a direction parallel to the plane of the main ground structure 302). Both the grounding conductor 220 and the depending tab 230 extend from a common edge (foreground edge in FIG. 2) of the first planar portion 214. A dotted line 232 schematically illustrates current flow in the antenna which as shown includes an electrical length increasing bend through the depending tab 230.

A signal feed tab 234 extends from the depending tab 230. Except for an end portion 236, the signal feed tab 234 lies in a plane that is perpendicular to a plane occupied by the first planar potion 214, but angled relative to a plane occupied by the depending tab 230. The end portion 236 is bent so as to lie in a plane parallel to the plane occupied by the depending tab 230. In this way the end portion 236 of the signal feed tab 234 is located proximate an end of the metal strip 212 used to support the first coaxial feed cable 206 that is used to feed the first antenna 108. Additionally the end portion 236 of the signal feed tab 234 aligns with an edge of the first planar portion 214 opposite to the edge of the first planar portion 214 from which the depending tab 230 extends.

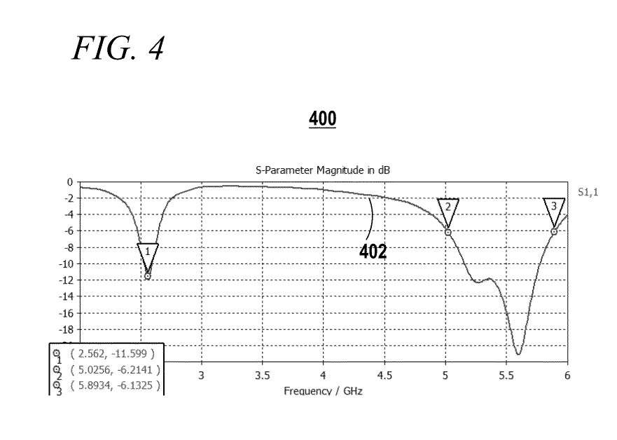

FIG. 4 is a graph 400 that includes a plot 402 of signal return loss for the antenna 108 shown in FIGS. 1-3. The abscissa of the graph denotes frequency in gigahertz (GHz), and the ordinate denotes magnitude of the reflection coefficient in decibels (dB). As shown in the graph 400 the reflection coefficient includes a first operating band centered at 2.562 GHz which is attributable to a first resonance of the antenna 108, and a second operating band that extends between 5.03 GHz and 5.8 GHz and is attributable to two resonances of the antenna 108. These frequency bands are appropriate for IEEE 802.11 communications. It will be apparent to persons of skill in the art that the antenna can be redimensioned and tuned to support communications in alternative frequency bands.

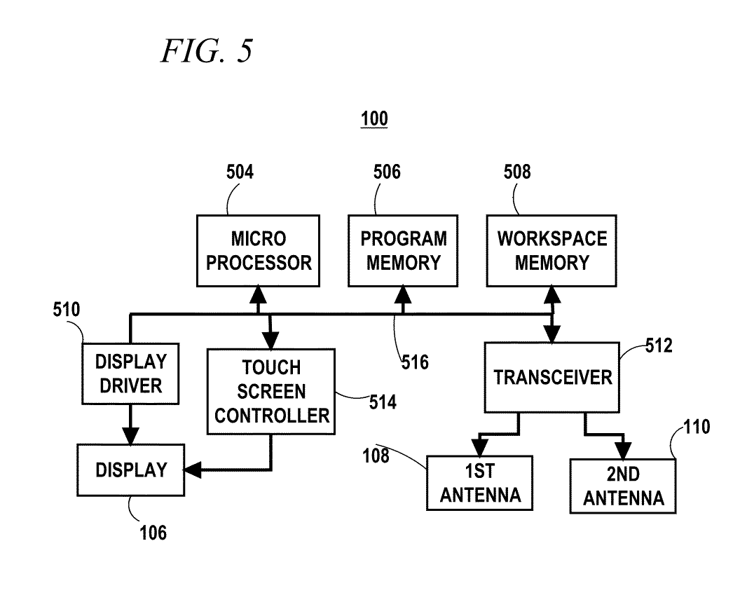

FIG. 5 is a functional block diagram of the hand held electronic device 100 shown in FIG. 1. As shown in FIG. 5 the device 100 comprises a microprocessor 504, a program memory 506, a workspace memory 508, a display driver 510, a touch screen controller 514 and a transceiver 512 coupled together through a signal bus 516. The display driver 510 and the touch screen controller are coupled to the display 106. And the transceiver 512 is coupled to the first antenna 108 and the second antenna 110.

In the foregoing specification, specific embodiments of the present invention have been described. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of present invention. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

We claim:

1. An antenna system comprising:
a first antenna comprising an elongated resonant structure having a first feed end and a second ground end;
a first feed cable coupled to said first feed end of said first antenna;
a second feed cable that extends proximate said first antenna, said second feed cable comprising an outer conductor;
wherein said ground end of said resonant structure is coupled to said outer conductor of said second feed cable.

2. The antenna system according to claim 1 further comprising a ground structure comprising an edge, wherein said first antenna is disposed proximate said edge of said ground structure and wherein said second feed cable extends between said elongated resonant structure of said first antenna and said edge of said ground structure.

3. The antenna system according to claim 2 wherein said ground end of said resonant structure comprises a depending leg that includes an end that includes a clip that engages said outer conductor of said second feed cable.

4. The antenna system according to claim 3 wherein said elongated resonant structure includes a high band tuning stub that extends in a direction parallel to said elongated resonant away from said first feed end and beyond said depending leg.

5. The antenna system according to claim 1 wherein said resonant structure includes a matching stub extending in a direction parallel to said elongated resonant structure said matching stub having a free end facing said first feed end.

6. The antenna system according to claim 1 wherein said elongated resonant structure is in a shape of a folded planar conductor including at least a first portion disposed in a first plane that is parallel to a longitudinal axis of said elongated structure and at least a second portion extending from said at least first portion at an angle so as to be disposed in a second plane that is parallel to said longitudinal axis but angled relative to said first plane.

7. The antenna system according to claim 5 wherein said angle is perpendicular.

8. The antenna system according to claim 5 wherein said first feed end comprises a strip extending from said at least second portion in a third plane that is substantially perpendicular to said first plane and angled relative to said second plane wherein said strip extends toward said first feed end of said antenna.

9. The antenna system according to claim 1 wherein said elongated resonant structure supports a first resonance at a first frequency, a second resonance at a second frequency and a third resonance at a third frequency.

10. The antenna system according to claim 9 wherein said first frequency, said second frequency and said third frequency are compatible with IEEE 802.11 communications.
